(19) United States
(12) Patent Application Publication
(10) Pub. No.: US 2019/0379011 A1
(43) Pub. Date: Dec. 12, 2019

(54) RECHARGEABLE BATTERY AND BATTERY MODULE

(71) Applicant: Samsung SDI Co., Ltd., Yongin-si (KR)

(72) Inventors: Taewon PARK, Yongin-si (KR); Yunki BAIK, Yongin-si (KR); Junmin CHOI, Yongin-si (KR)

(21) Appl. No.: 16/420,104

(22) Filed: May 22, 2019

(30) Foreign Application Priority Data
Jun. 12, 2018 (KR) 10-2018-0067515

(51) Int. Cl. H01M 2/04; H01M 2/10; H01M 2/20; H01M 2/12; H01M 2/26

(52) U.S. Cl. CPC H01M 2/0404; H01M 2/1061; H01M 2/204; H01M 2200/20; H01M 2/1241; H01M 2/26; H01M 2/1252

(57) ABSTRACT

A rechargeable battery includes: an electrode assembly that includes a first electrode, a second electrode, and a separator; a case that accommodates the electrode assembly, and includes an open side; and a cap plate coupled to the open side of the case, the cap plate including a plurality of vent portions configured to be ruptured by an internal pressure of the case, wherein the plurality of vent portions are arranged along a length direction of the cap plate.

### CROSS-REFERENCE TO RELATED APPLICATION

This application claims priority to and the benefit of Korean Patent Application No. 10-2018-0067515 filed in the Korean Intellectual Property Office on Jun. 12, 2018, the entire contents of which are incorporated herein by reference.

### BACKGROUND

### 1. Field

Embodiments of the present disclosure relate to a rechargeable battery and a battery module, and for example, to a rechargeable battery having a vent portion that emits a gas to the outside upon an increase of an internal pressure of a case, and a battery module.

### 2. Description of the Related Art

A rechargeable battery is a battery that is designed to repeatedly perform charging and discharging, differently from a primary battery. A rechargeable battery having a small capacity is used in a small portable electronic device such as a mobile phone, a notebook computer, and a camcorder, and a rechargeable battery having a large capacity may be used as a motor driving power source for a hybrid vehicle and an electric vehicle.

The rechargeable battery may be used as, for example, a single cell like the rechargeable battery in a small electronic device, or may be used in a module state in which a plurality of cells is electrically coupled such as, for example, in the rechargeable battery for driving a motor. For example, the battery module may include a bus bar that electrically couples the plurality of unit cells.

In the rechargeable battery, a cap plate is combined with an opening of a case that accommodates an electrode assembly, and the cap plate may include a vent portion that is ruptured by an internal pressure of the rechargeable battery and a vent hole is opened.

When the rechargeable battery undergoes an abnormal phenomenon such as an internal temperature increase due to various causes, an internal pressure may be increased by a gas generated due to a chemical reaction, electrochemical reaction, and/or the like. A unit cell in which an abnormal phenomenon occurs may discharge the gas through the vent portion or the like in response to the increase of the internal pressure, thereby preventing or reducing occurrence of a dangerous situation such as an explosion and/or the like.

Further, when the unit cell where an abnormal phenomenon occurs is included in a battery module, it is important to maintain safety of the battery module by, for example, effectively discharging a leaked gas through a vent portion of the unit cell.

The above information disclosed in this Background section is only for enhancement of understanding of the background of the present disclosure and therefore it may contain information that does not form the prior art that is already known in this country to a person of ordinary skill in the art.

### SUMMARY

Exemplary embodiments of the present disclosure have been made in an effort to provide a rechargeable battery and a battery module that can effectively solve or reduce an increase of an internal pressure in the rechargeable battery and/or battery module due to an abnormal phenomenon.

In addition, exemplary embodiments of the present disclosure provide a rechargeable battery that can effectively suppress or reduce secondary damage such as, for example, deterioration due to a high-temperature gas generated due to the abnormal phenomenon by effectively discharging the gas.

A rechargeable battery according to an exemplary embodiment of the present disclosure includes: an electrode assembly that includes a first electrode, a second electrode, and a separator; a case that accommodates the electrode assembly, and includes an open side; and a cap plate coupled to the open side of the case, the cap plate including a plurality of vent portions configured to be ruptured by an internal pressure of the case, wherein the plurality of vent portions are arranged along a length direction of the cap plate.

At least one of the plurality of vent portions may be located at each end of the cap plate.

At least one of the plurality of vent portions may be located at a center of the cap plate.

Each vent portion may include: a break portion having a first notch configured to be ruptured by the internal pressure; and a no-break portion coupled with the break portion, where, when the break portion is ruptured, a gas may be discharged to a direction that faces toward the break portion from the no-break portion in each vent portion.

A second notch that is straight-lined may be coupled with the first notch, the second notch having a depth that is smaller than that of the first notch in the no-break portion, and where the second notch may become a rotation shaft of the break portion when the first notch is ruptured.

The rechargeable battery may further include an electrode terminal that protrudes from the cap plate and is electrically coupled with the electrode assembly, wherein, in the vent portion, a direction that faces toward the break portion from the no-break portion may be set to avoid the electrode terminal.

The electrode terminal may be provided as a pair of electrode terminals that are respectively located at opposite ends of the cap plate, and where the plurality of vent portions may be between the pair of electrode terminals and the direction that faces toward the break portion from the no-break portion may be set to face a center of the cap plate in each vent portion.

The electrode terminal is provided as a pair of electrode terminals that are respectively located at opposite ends of the cap plate, and where the plurality of vent portions may be located further away from a center of the cap plate than the pair of electrode terminals, and a direction that faces toward the no-break portion from the break portion may be set to face toward the center of the cap plate.

A battery module according to an exemplary embodiment of the present disclosure includes: a plurality of rechargeable batteries each including a case that accommodates an electrode assembly, a cap plate coupled to one side of the case, and a plurality of vent portions in the cap plate along a length direction of the cap plate, where a vent line extends along an alignment direction of the plurality of rechargeable batteries, the vent line being configured to receive a gas emitted from the plurality of vent portions.

The electrode terminal may be a pair of electrode terminals that are respectively located at opposite ends of the cap plate, each of the vent portions may include: a break portion having a first notch configured to be ruptured by an internal pressure of the case; and a no-break portion coupled with the break portion that may be located between the pair of electrode terminals, a direction that faces toward the break portion from the no-break portion may be set to face toward the vent line, and the vent line may be located to pass through a center side of the cap plate.

The electrode terminal may be a pair of electrode terminals that are respectively located at opposite ends of the cap plate, each of the vent portions may include: a break portion having a first notch configured to be ruptured by an internal pressure of the case; and a no-break portion coupled with the break portion, where the no-break portion may be between the pair of electrode terminals, a direction that faces toward the break portion from the no-break portion may be set to face toward the vent line, and where the vent line includes a pair of vent lines that are respectively located at the opposite ends of the cap plate, and located further away from the center of the cap plate than the pair of electrode terminals.

According to exemplary embodiments of the present disclosure, an increase of an internal pressure due to an abnormal phenomenon can be effectively solved or reduced.

In addition, a gas generated due to the abnormal phenomenon is effectively discharged or reduced to thereby effectively suppress or reduce a secondary damage due to a high-temperature gas.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a perspective view showing a rechargeable battery according to an exemplary embodiment of the present disclosure.

FIG. 2 is an internal cross-sectional view of the rechargeable battery according to an exemplary embodiment of the present disclosure.

FIGS. 3A and 3B include images showing a comparison of an internal pressure change between a rechargeable battery provided with a single vent portion and a rechargeable battery provided with a plurality of vent portions.

FIG. 4 includes top views illustrating various exemplary embodiments of rechargeable batteries having a plurality of vent portions.

FIG. 5 includes top views illustrating various exemplary embodiments of shapes of the vent portion of the rechargeable battery according to the present disclosure.

FIG. 6 includes top views illustrating various exemplary embodiments of gas discharge directions G in the vent portion of the rechargeable battery according to the present disclosure.

FIG. 7 is a perspective view showing a battery module provided with one vent line according to an exemplary embodiment of the present disclosure.

FIG. 8 is a perspective view showing a battery module provided with a plurality of vent lines according to an exemplary embodiment of the present disclosure.

### DETAILED DESCRIPTION

In the following detailed description, only certain exemplary embodiments of the present disclosure have been shown and described, simply by way of illustration.

As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

In the present specification, duplicative description of the same components may not be repeated.

Further, in the present specification, it is to be understood that when one component is referred to as being “connected to” or “coupled to” another component, it may be directly connected or coupled to another component or be indirectly connected or coupled to the other component with still another component interposed therebetween. On the other hand, in the present specification, it is to be understood that when one component is referred to as being “directly connected to” or “directly coupled to” another component, it may be connected or coupled to the other component without any other component interposed therebetween.

In addition, terms used in the present specification are used only in order to describe example embodiments rather than limiting the present disclosure.

Further, in the present specification, singular forms are intended to include plural forms unless the context clearly indicates otherwise.

It should be further understood that terms “include” or “have” used in the present specification specify the presence of features, numerals, actions, operations, components, parts mentioned in the present specification, or combinations thereof, but do not preclude the presence or addition of one or more other features, numerals, actions, operations, components, parts, or combinations thereof.

Further, in the present specification, a term ‘and/or’ includes a combination of a plurality of stated items or any one of the plurality of stated items. In the present specification, ‘A or B’ may include ‘A’, ‘B’, or ‘both A and B’.

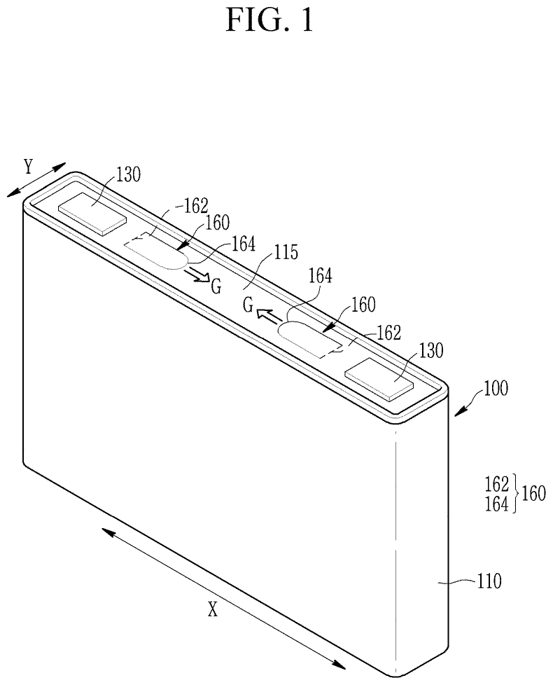

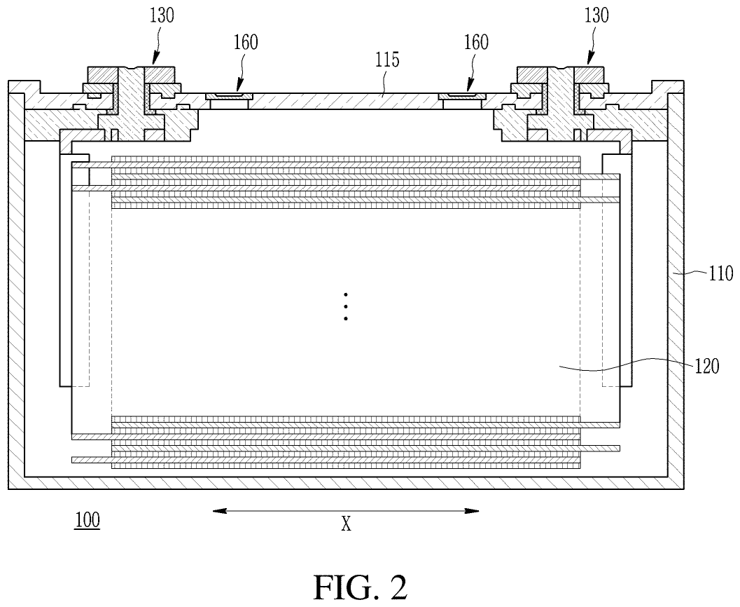

FIG. 1 illustrates a rechargeable battery 100 according to an exemplary embodiment of the present disclosure. The rechargeable battery 100 according to an exemplary embodiment of the present disclosure includes an electrode assembly 120 (shown in FIG. 2) that includes a first electrode, a second electrode, and a separator, a case 110 where the electrode assembly 120 is received (or accommodated) and having one opened side, and a cap plate 115 that is combined with the opened side of the case 110 and includes a plurality of vent portions 160 opened by an internal pressure of the case 110, and the plurality of vent portions 160 are arranged along a length direction X of the cap plate 115.

FIG. 2 illustrates an internal cross-section of the rechargeable battery 100 according to an exemplary embodiment of the present disclosure. Referring to FIG. 1 and FIG. 2, the electrode assembly 120 includes a first electrode, a second electrode, and a separator, and the case 110 includes one opened side and the cap plate 115 is combined with the opened side.

The electrode assembly 120 may be provided in various suitable shapes such as a stacked shape or a spirally wound shape as necessary or desired, and the case 110 may be formed in the shape of a cylinder or a quadrangular column (e.g., a rectangular prism or cuboid shape). Hereinafter, for convenience of description of the present disclosure, as shown in FIG. 1 and FIG. 2, the case 110 will be exemplarily described as a quadrangular column having a rectangular cross-section.

The case 110 has one opened side, and the opened side may be a top surface, a side surface, or a bottom surface of the case 110, and in FIG. 1 and FIG. 2, the case 110 of which the top surface is opened is illustrated according to an exemplary embodiment of the present disclosure.

A space for receiving (or accommodating) the electrode assembly 120 is provided in the case 110, and the electrode assembly 120 is inserted into the case 110 through the opened side of the case 110 and then the cap plate 115 is combined to the opened side of the case 110 to close and seal the inside of the case 110.

Meanwhile, in the rechargeable battery 100 according to an exemplary embodiment of the present disclosure, the plurality of vent portions 160 may be provided in the cap plate 115, and they can be opened when an internal pressure of the case 110 reaches a set or predetermined pressure and may be arranged along the length direction X of the cap plate 115.

The vent portions 160 may be provided with various suitable shapes and through various suitable methods. In FIG. 1 to FIG. 2, a vent portion 160 in which a notch is formed, which is ruptured when an internal pressure of the case 110 exceeds a set or predetermined pressure according to an exemplary embodiment of the present disclosure, is schematically illustrated.

In the case 110, the electrode assembly 120 chemically or electrochemically reacts with an electrolyte solution, and the chemical reaction (or electrochemical reaction) may proceed rapidly in the inside of the rechargeable battery 100 due to an abnormal situation such as, for example, generation of a high temperature at the periphery thereof.

The rapid chemical reaction (or electrochemical reaction) in the rechargeable battery 100 causes an increase of an internal temperature and generation of a large amount of gas, thereby causing an increase of internal pressure in the case 110. Embodiments of the present disclosure effectively prevent or reduce the increase of internal pressure in the case 110 by setting the vent portions 160 to be opened at a set or predetermined pressure.

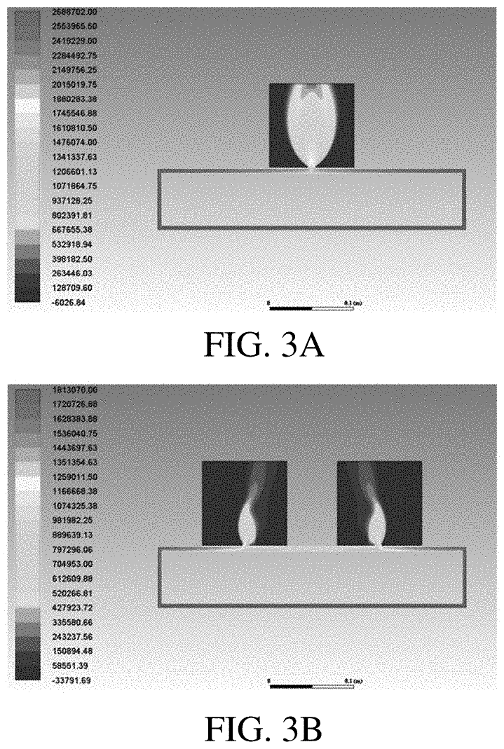

A case in which a single vent portion 160 is provided to solve or reduce internal pressure is illustrated in FIG. 3A, and a case in which a plurality of vent portions 160 are provided to solve or reduce an internal pressure is illustrated in FIG. 3B. FIG. 3B exemplarily illustrates a rechargeable battery 100 including two vent portions 160.

Referring to FIGS. 3A and 3B, compared to the rechargeable battery 100 including a single vent portion 160, the rechargeable battery 100 including a plurality of vent portions 160 can effectively solve or reduce the buildup of internal pressure. As described herein, according to an exemplary embodiment of the present disclosure, a plurality of vent portions 160 are provided to effectively solve or reduce the buildup of internal pressure of the rechargeable battery 100.

Meanwhile, in an exemplary embodiment of the present disclosure, the cap plate 115 and the case 110 respectively have the length direction X, and the plurality of vent portions 160 are arranged along the length direction of the cap plate 115. Accordingly, occurrence of a rupture due to an excessive increase of internal pressure at any side in the cap plate 115 that is combined to the case 110 by welding and/or the like can be effectively suppressed reduced.

However, an arrangement structure of the vent portions 160 of the present disclosure is not limited thereto, and the number of vent portions 160 can be variously determined as appropriate or necessary in consideration of the shape of the cap plate 115, and an internal pressure analysis result or capacity of the cap plate 115.

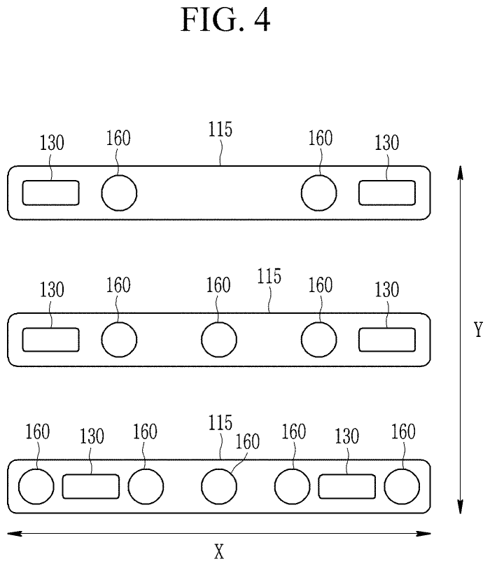

Meanwhile, in FIG. 4, various exemplary embodiments in which a plurality of vent portions 160 are provided are exemplarily illustrated. For example, the top image of FIG. 4 shows an exemplary embodiment in which two vent portions 160 are provided, the middle image of FIG. 4 shows an exemplary embodiment in which three vent portions 160 are provided, and the bottom image of FIG. 4 shows an exemplary embodiment in which five vent portions 160 are provided.

In the respective exemplary embodiments of the present disclosure, at least one of the plurality of vent portions 160 may be located at opposite ends of the cap plate 115.

In the rechargeable battery where the cap plate 115 is combined with the opened one side of the case 110, when an internal pressure is increased due to gas generation, the pressure may be concentrated at each edge of the rechargeable battery 100, and, for example, the pressure may be concentrated at opposite ends of the cap plate 115 in which three edges meet each other and thus an apex is formed, such that it may be broken.

Further, when the gas generated due to the chemical reaction (or electrochemical reaction) of the electrode assembly 120 is concentrated at the opposite ends of the length direction X of the cap plate 115 and the case 110 such as when the electrode assembly 120 is formed in the shape of a spiral and a spiral-wound shaft is provided in parallel (e.g., substantially in parallel) with the length direction X of the cap plate 115, an internal pressure may be excessively increased at the opposite ends of the cap plate 115.

Referring back to FIGS. 3A and 3B, in both cases of FIG. 3A in which the single vent portion 160 is provided and FIG. 3B in which two vent portions 160 are provided, the internal pressure is excessively increased at opposite ends of the cap plate 115.

Accordingly, in an exemplary embodiment of the present disclosure, at least one vent portion 160 is provided at each of the opposite ends of the cap plate 115 to effectively reduce the internal pressure, which may be concentrated at the opposite ends of the cap plate 115.

In the rechargeable battery 100 according to an exemplary embodiment of the present disclosure, at least one of the plurality of vent portions 160 may be located at a center of the cap plate 115.

As shown in the middle or bottom images of FIG. 4, the vent portions 160 may be provided at opposite ends of the cap plate 115, and may be further provided at a center of the cap plate 115.

Thus, in the rechargeable battery 100 according to an exemplary embodiment of the present disclosure, at least one vent portion 160 is provided at each of the opposite ends and the center portion of the cap plate 115, and thus, the internal pressure of the case 110, which is increased due to an abnormal condition, can be effectively solved or reduced.

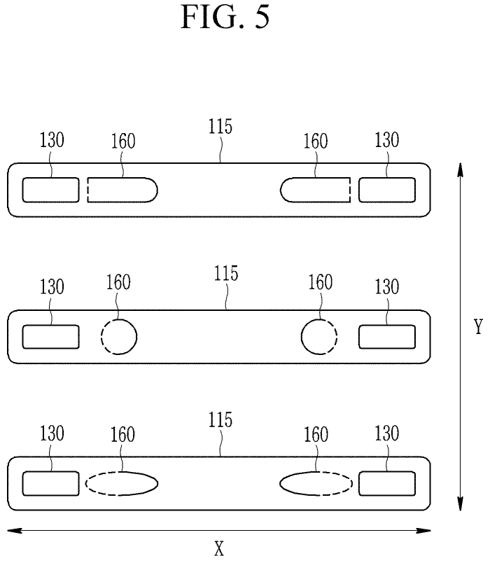

Meanwhile, FIG. 5 illustrates various exemplary embodiments of shapes of the vent portion 160 of the rechargeable battery 100 according to the present disclosure. In an exemplary embodiment shown in FIG. 5, a notch is formed in the vent portion 160 and the notch is ruptured, and thus, opened at a set or predetermined pressure.

For example, the top image of FIG. 5 shows a vent portion 160 in which a substantially arc-shaped notch is formed at one side thereof, the middle image of FIG. 5 shows a vent portion 160 in which a substantially circular shaped notch is formed, and the bottom image of FIG. 5 shows a vent portion 160 in which a substantially oval shaped notch is formed.

In an exemplary embodiment of the present disclosure, the vent portion 160 includes a break portion 164 where a first notch that can be ruptured by the internal pressure is formed and a no-break portion 162 coupled with the break portion 164, and when the break portion 164 is broken, a gas that flows toward the break portion 164 from the no-break portion 162 may be discharged.

In the vent portion 160, the break portion 164 where a first notch may be formed at one side, and the no-break portion 162, which is not ruptured even at a set or predetermined pressure at which the first notch is ruptured, may be provided at the other side.

In the vent portion 160, the first notch may be formed as a part of the cap plate 115 on the cap plate 115, and as shown in FIG. 2, the vent portion 160 may include vent holes formed on the cap plate 115 and a vent plate combined with the vent holes and where the first notch is formed

Such a structure of the vent portion 160 may vary as necessary or desired.

Meanwhile, the set or predetermined pressure that causes the break portion 154 to be ruptured by the first notch may be determined by adjusting a depth or a width of the first notch, and the depth of the first notch may be set according to a position of the vent portion 160.

A second notch that is smaller than the first notch in depth and/or the like is provided at the no-break portion 162, and thus, no rupture occurs at the no-break portion 162 at the set or predetermined pressure, or no notch is formed in the no-break portion 162, and thus, the no-break portion 162 is not ruptured.

In the vent portions 160 of the various exemplary embodiments shown in FIG. 5, the solid line denotes the first notch that forms the break portion 164 and the dotted line implies that the second notch is formed or no notch is formed, and the dotted line corresponds to the no-break portion 162.

In an exemplary embodiment of the present disclosure, the vent portion 160 is opened as the break portion 164 is ruptured due to an increase of internal pressure of the case 110, while the no-break portion 162 is not ruptured, such that the internal gas of the case 110 is discharged toward the break portion 164 from the no-break portion 162.

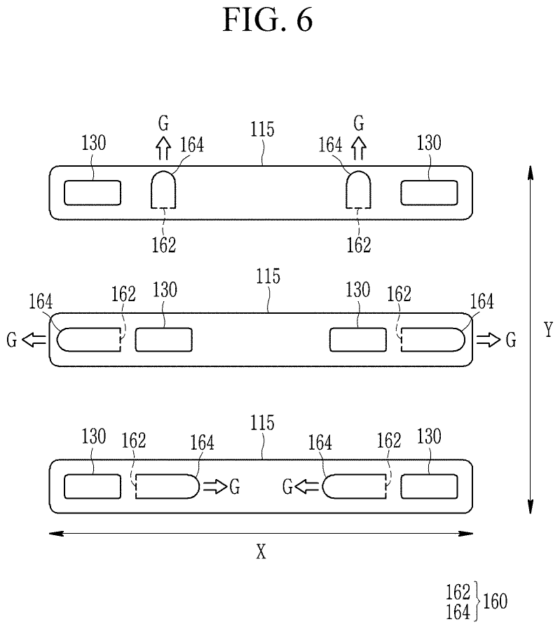

In FIG. 6, various exemplary embodiments of gas discharge directions G in the vent portion 160 are illustrated. According to an exemplary embodiment of the present disclosure, the no-break portion 162 and the break portion 164 are formed in the vent portion 160 such that the discharge direction G of the case can be variously set, thereby effectively discharging the gas discharged from the case 110 and preventing or reducing deterioration due to a high-temperature gas.

Meanwhile, in an exemplary embodiment of the present disclosure, a straight-lined second notch that is smaller than the first notch in depth and coupled with the first notch is formed in the no-break portion 162, and the second notch may become a rotation shaft of the break portion 164 when the first notch is ruptured.

Depending on exemplary embodiments of the present disclosure, the dotted line portion of the vent portion 160 shown in FIG. 5 and FIG. 6 may correspond to the second notch and may form the no-break portion 162. As described hereinabove, the second notch is not ruptured even at the set or predetermined pressure at which the first notch is ruptured, and thus, the second notch may function as a rotation shaft of the break portion 164 when the break portion 164 is opened.

A straight-lined second notch is formed in the no-break portion 162, and, for example, the second notch extends in a length direction that is perpendicular (e.g., substantially perpendicular) to the gas discharge direction G such that the second notch functions as a rotation shaft for the break portion 164 when the break portion 164 is opened.

Compared to a case in which no notch is formed, the second notch is formed in the no-break portion 162, and thus, a plate portion of the break portion 164 according to opening of the break portion 164 can be more easily rotated, and accordingly, the gas discharge direction G can be effectively set and the vent portion 160 can be effectively opened.

Referring to FIG. 6, the top image of FIG. 6 is an exemplary embodiment in which the gas discharge direction G of the vent portion 160 is set to be parallel (e.g., substantially parallel) with a width direction Y of the cap plate 115, the middle image of FIG. 6 is an exemplary embodiment in which the gas discharge direction G of the vent portion 160 is parallel (e.g., substantially parallel) with the length direction X of the cap plate 115 and faces toward an outer side of the cap plate 115, and the bottom image of FIG. 6 is an exemplary embodiment in which the gas discharge direction G of the vent portion 160 is parallel (e.g., substantially parallel) with the length direction X of the cap plate 115 and faces toward a center side of the cap plate 115.

As shown in FIG. 6, according to an exemplary embodiment of the present disclosure, electrode terminals 130 that are formed while protruding from the cap plate 11 are electrically coupled with the electrode assembly 120, and, in the vent portion 160, a direction that faces toward the break portion 164 from the no-break portion 162 may be set to avoid (or to be directed away from) the electrode terminals 130.

The top image, middle image, and bottom image of FIG. 6 correspond to various exemplary embodiments in which the gas discharge direction G of the vent portion 160 is set to avoid (or to be directed away from) the electrode terminals 130. The electrode terminal 130 may be on the cap plate 115, and may be electrically coupled with the electrode assembly 120 in the case 120.

Meanwhile, when an internal pressure of the rechargeable battery 100 is increased due to an abnormal situation, and thus, the vent portions 160 are opened, a gas discharged from the vent portions 160 increases a temperature such that elements that contact the gas may be deteriorated due to the high-temperature gas.

The electrode terminals 130 may be formed on the cap plate 115 to protrude therefrom, and according to an exemplary embodiment of the present disclosure, the gas discharge directions G of the vent portions 160 are set to avoid (or to be directed away from) the electrode terminals 130, thereby preventing or reducing deterioration of the electrode terminals 130.

The gas discharge direction G which avoids the electrode terminals 130 may vary, and as shown in the various exemplary embodiments of FIG. 6, the gas discharge direction G may be set toward a side direction of the cap plate 115, toward an outer side direction along the length direction X, toward a center direction along the length direction X, or to a diagonal direction depending on a position of the correction vent portion 160 and a position of an adjacent electrode terminal 130.

In an exemplary embodiment of the present disclosure, as shown in the bottom image of FIG. 6, the electrode terminals 130 a pair of electrode terminals that are respectively located at opposite ends of the cap plate 115, the plurality of vent portions 160 are between the pair of electrode terminals 130, and a direction of each of the vent portions 160, facing toward the break portion 164 from the no-break portion 162, may be set toward a center of the cap plate 115.

In some embodiments, the electrode terminals 130 are provided as a pair, and thus, may be respectively located at opposite ends of the cap plate 115, at least a part of the vent portion 160 may be located closer to the center of the cap plate 115 than the electrode terminal 130 while being located close to each electrode terminal 130.

In an exemplary embodiment of the present disclosure, in the vent portion 160, as shown the bottom image of FIG. 6, the no-break portion 162 is located to face the electrode terminal 130 and the break portion 164 is located to face toward the center side of the cap plate 115.

Accordingly, the gas discharge direction G of the vent portion 160 is set toward the center side of the cap plate 115 while being parallel (e.g., substantially parallel) with the length direction X of the cap plate 115. For example, the gas discharge direction G in the vent portion 160 that is located closer to the center of the cap plate 115 than the electrode terminal 130 is set toward the opposite side of the electrode terminal 130 such that a high-temperature gas is discharged while avoiding the electrode terminals 130, thereby preventing or reducing deterioration of the electrode terminals 130.

Further, since all (or substantially all) of the gas discharged from the plurality of vent portions 160 is discharged to the center side of the cap plate 115, it is easy to move and discharge the gas to the outside of the battery module 200, and this will be described in more detail herein below.

In another exemplary embodiment of the present disclosure, as shown in the middle image of FIG. 6, the electrode terminal 130 is provided as a pair, and thus, are respectively provided at opposite ends of the cap plate 115, the plurality of vent portions 160 are located further away from the center of the cap plate 115 than the pair of electrode terminals 130, and a direction that faces toward the no-break portion 162 from the break portion 164 may be set to face toward the center of the cap plate 115.

In some embodiments, the plurality of vent portions 160 may be provided as at least a pair, may be respectively located adjacent to the electrode terminals 130 at opposite ends of the cap plate, and may be located further away from the center of the cap plate 115 than the electrode terminal 130. For example, the plurality of vent portions 160 may be located further outer than the pair of electrode terminals 130 with reference to the length direction X of the cap plate 115.

In the vent portion 160, a direction that faces toward the no-break portion 162 from the break portion 164 may be set to face toward the center of the cap plate 115. For example, in the vent portion 160, a direction that faces toward the break portion 164 from the no-break portion 162, that is a gas discharge direction G, is set toward an outer side of the cap plate 116 as shown in the middle image of FIG. 6, and accordingly, the gas does not flow toward the electrode terminal 130.

Accordingly, deterioration of the electrode terminal 130 due to the gas emitted from the vent portion 160 can be prevented or reduced, and this may be a feature of gas flow management and layout design. For example, a control module can be located at a center side of the battery module 200 because the gas emitted from the vent portion 160 can be discharged to the outside of the battery module 160 by moving the gas at the opposite ends of the rechargeable battery 100.

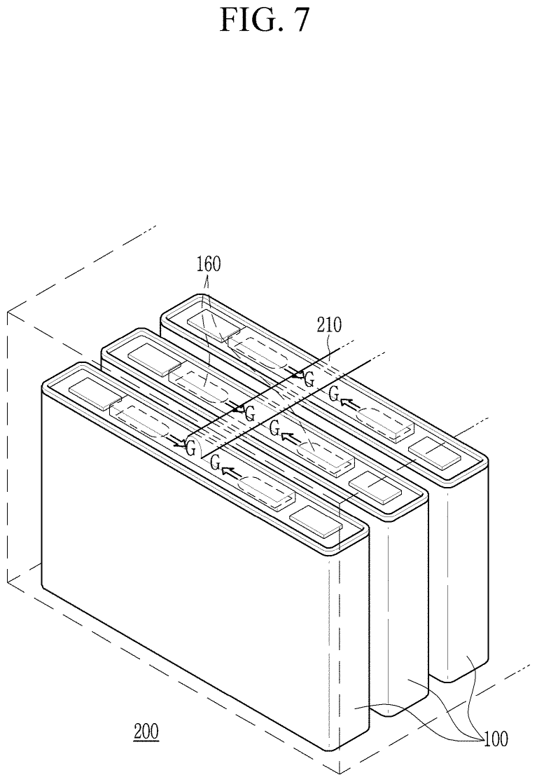

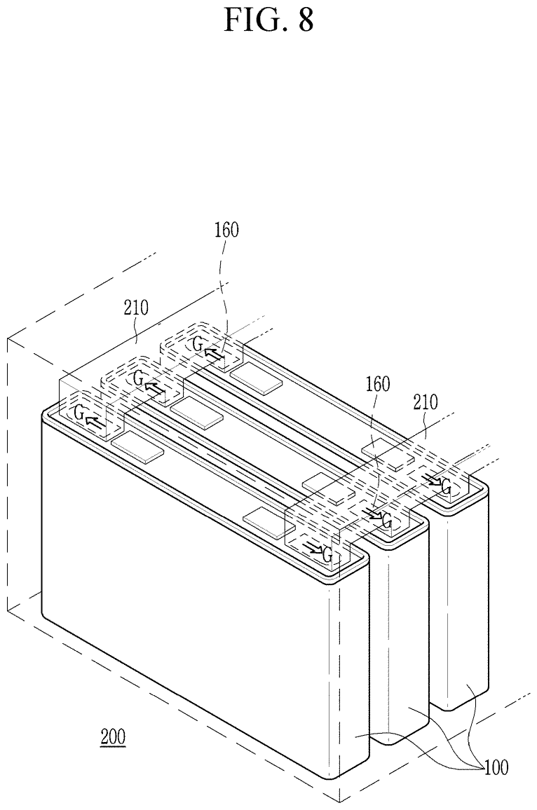

Referring to FIG. 7 and FIG. 8, a battery module 200 according to an exemplary embodiment of the present disclosure is illustrated. As shown in FIG. 7, a battery module 200 according to an exemplary embodiment of the present disclosure includes a plurality of rechargeable batteries 100, each of which includes a cap plate 115 combined with one side of a case 110 that receives an electrode assembly 120 and in which a plurality of vent portions 160 are provided in the cap plate 115 along a length direction X, and a vent line 210 that extends along an alignment direction of the rechargeable batteries 110 and through which a gas discharged from the plurality of vent portions 160 is introduced.

Referring to FIG. 7, the above-described rechargeable battery 100 may be provided in plural in the battery module 200 according to an exemplary embodiment of the present disclosure. In the description of the rechargeable battery 100, duplicative description of features that are the same as the above-described features will not be repeated here.

An exact number of the plurality of rechargeable batteries 100 provided in the battery module 200 may be variously determined depending on the use of the battery module 200 or the desired or required power, and whether the plurality of rechargeable batteries 100 are coupled in series or in parallel with each other.

The rechargeable batteries 100 may be arranged in various suitable manners, and, for example, they may be arranged in a row along a width direction Y of the cap plate 115 as shown in FIG. 7.

In the battery module 200 according to an exemplary embodiment of the present disclosure, a gas discharged from the plurality of vent portions 160 provided in the rechargeable batteries 100 is introduced into the vent line 210 provided in the battery module 200 and is then discharged to the outside of the battery module 200.

Accordingly, although the plurality of vent portions 160 are provided in each of the rechargeable batteries 100 of the battery module 200, the gas can be effectively discharged to the outside of the battery module 200 even through a single or smaller number of vent lines 210 than the number of vent portions 160.

Meanwhile, as shown in FIG. 7, in the battery module 200 according to an exemplary embodiment of the present disclosure, an electrode terminal 130 is provided as a pair in each of the rechargeable batteries 100 and located at each of opposite ends of the cap plate 115, and the vent portion 160 includes a break portion 164 in which a first notch that is ruptured by internal pressure of the case 110 is formed and a no-break portion 162 coupled with the break portion 164 and located between the pair of electrode terminals 130. A direction toward the break portion 164 from the no-break portion 162 is set toward the vent line 210, and the vent line 210 may be located to pass through a center of the cap plate 115.

In some embodiments, each rechargeable battery 100 of the battery module 200 may correspond to the rechargeable battery 100 shown in the middle image of FIG. 6, and the battery module 200 may be provided with a module case that receives the plurality of rechargeable batteries 100. A cap plate 115 and a vent module 160 of each rechargeable battery 100 may be provided in an upper portion of the rechargeable battery 100, and a vent line 210 is provided in an upper portion of the module case, and thus, may be located at an upper side of the plurality of rechargeable batteries 100.

The vent line 210 may be provided as a hollow type (or kind) of pipe through which a gas flows, and may extend in an alignment direction of the plurality of rechargeable batteries 100.

In the exemplary embodiment shown in FIG. 7, the vent portion 160 of each rechargeable battery 100 is located between a pair of electrode terminals 130, and a gas discharge direction G that faces toward the break portion 164 from the no-break portion 162 may be set to face a center of the cap plate 115.

Meanwhile, the vent line 210 may be located at an upper center portion of the cap plate 115 in each rechargeable battery 110 in the upper portion of the module case of the battery module 200, and a gas discharged from the plurality of vent portions 160 may be introduced into the vent line 210, and thus, discharged to the outside of the battery module 200.

In some embodiments, the vent line 210 may be provided as a single vent line 210, or the vent line 210 may be provided as a plurality of vent lines depending on the capacity of each of the rechargeable batteries 100 or the number of vent portions 160. The vent line 210 may include an extension portion that extends along the alignment direction of the rechargeable batteries 100, and a cover portion that protrudes from the extension portion and is located in an upper side of the vent portions 160 of each rechargeable battery 100 such that a gas is introduced therein.

The extension portion and the cover portion may be provided with various suitable shapes, and the cover portion extends to protrude along the length direction X of the cap plate 115 of each rechargeable battery 100 from the extension portion to cover the plurality of vent portions 160 provided in one of the rechargeable batteries 100. Accordingly, a gas discharged from a plurality of vent portions 160 provided in any one of the rechargeable batteries 100 may be introduced into the extension portion via the inside of any one of the cover portions.

As described herein, in the battery module 200 according to an exemplary embodiment of the present disclosure, even though a plurality of vent portions 160 are formed in each of the plurality of rechargeable batteries 100 as shown in FIG. 7, configurations of the vent line 210 and related elements for discharging a gas to the outside of the battery module 200 can be minimized or reduced, while effectively discharging the gas, and accordingly it may be a feature in the design of the battery module 200.

FIG. 8 illustrates a battery module 200 according to another exemplary embodiment of the present disclosure. As shown in FIG. 8, in the battery module 200 according to the present exemplary embodiment, an electrode terminal of each rechargeable battery 100 includes a pair of electrode terminals that are located at opposite ends of a cap plate 115, and a vent portion 160 includes a break portion 164 where a first notch ruptured by an internal pressure is formed and a no-break portion 162 coupled with the break portion 164. The vent portion 160 may be located further away from the center of the cap plate 115 than the pair of the electrode terminal 130, and a direction that faces toward the break portion 164 from the no-break portion 162 is set to face toward the vent line 120, and the vent line 210 is provided at each of the opposite ends of the cap plate 115 and may be located farther away from a center of the cap plate 115 than the pair of the electrode terminals 130.

Each rechargeable battery of the battery module 200 may correspond to the rechargeable battery 100 shown in the middle image of FIG. 6, and the vent lines 210 of the battery module 200 may be provided as a pair and be respectively provided at opposite ends of the cap plate 115 in an upper portion of a module case.

In some embodiments, the vent line 210 may be provided as single objects at opposite ends of the cap plate 115, respectively, or the vent line 210 may be provided as a plurality of vent lines in each of the opposite ends of the cap plate 115 depending on the capacity of each rechargeable battery 100 or the number of the vent portions 160. Each vent line 210 may include an extension portion extending in an alignment direction of the rechargeable batteries 100, and a cover portion that protrudes from the extension portion and is located at an upper portion of the vent portion 160 of each rechargeable battery 100 such that a gas is introduced therein.

A cover portion extended from any one vent line 210 may protrude downward from the extension portion to cover vent portions 160 at a lower portion of each rechargeable battery. For example, the cover portion may be provided in plural in each vent line 210 to cover the vent portion 160 at the lower portion of the vent line 210.

A battery module 200 may be provided with a control module for managing operation of the battery module 200 while sensing a voltage state, a temperature, and an abnormal condition of the plurality of rechargeable batteries 100, and in case of the battery module 200 according to the exemplary embodiment shown in FIG. 8, the control module is located at a center portion of an upper portion of the module case and the vent lines 210 may be located at opposite sides of the control module such that it may be a feature of space utilization and design.

For example, in the exemplary embodiment of the present disclosure shown in FIG. 8, the control module is located at the center of the module case to effectively manage the plurality of rechargeable batteries 100, and the pair of vent lines 210 are provided not only to prevent or reduce deterioration of the electrode terminals 130 but also to effectively discharge a gas from the plurality of rechargeable batteries 100 to the outside of the battery module 200.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the subject matter of the present disclosure has been described in connection with what is presently considered to be practical exemplary embodiments, it is to be understood that the present disclosure is not limited to the disclosed embodiments. On the contrary, it is intended to cover various modifications and equivalent arrangements included within the spirit and scope of the appended claims.

### DESCRIPTION OF THE SYMBOLS

| | |
|---|---|
| 100: rechargeable battery | 110: case |
| 115: cap plate | 120: electrode assembly |
| 130: electrode terminal | 160: vent portion |
| 162: no-break portion | 164: break portion |
| 200: battery module | 210: vent line |

What is claimed is:

1. A rechargeable battery comprising:
an electrode assembly comprising a first electrode, a second electrode, and a separator;
a case that accommodates the electrode assembly, and comprises an open side; and
a cap plate coupled to the open side of the case, the cap plate comprising a plurality of vent portions configured to be ruptured by an internal pressure of the case,
wherein the plurality of vent portions are arranged along a length direction of the cap plate.

2. The rechargeable battery of claim 1, wherein at least one of the plurality of vent portions is located at each end of the cap plate.

3. The rechargeable battery of claim 2, wherein at least one of the plurality of vent portions is located at a center of the cap plate.

4. The rechargeable battery of claim 1, wherein each vent portion comprises:
a break portion having a first notch configured to be ruptured by the internal pressure; and
a no-break portion coupled with the break portion,
wherein, when the break portion is ruptured, a gas is discharged to a direction that faces toward the break portion from the no-break portion in each vent portion.

5. The rechargeable battery of claim 4, wherein a second notch that is straight-lined is coupled with the first notch, the second notch having a depth that is smaller than that of the first notch in the no-break portion, and
wherein the second notch becomes a rotation shaft of the break portion when the first notch is ruptured.

6. The rechargeable battery of claim 4, further comprising an electrode terminal that protrudes from the cap plate and is electrically coupled with the electrode assembly,
wherein, in the vent portion, a direction that faces toward the break portion from the no-break portion is set to avoid the electrode terminal.

7. The rechargeable battery of claim 6, wherein the electrode terminal is provided as a pair electrode terminals that are respectively located at opposite ends of the cap plate, and
wherein the plurality of vent portions are between the pair of electrode terminals and the direction that faces toward the break portion from the no-break portion is set to face a center of the cap plate in each vent portion.

8. The rechargeable battery of claim 6, wherein the electrode terminal is provided as a pair electrode terminals that are respectively located at opposite ends of the cap plate, and
wherein the plurality of vent portions are located further away from a center of the cap plate than the pair of electrode terminals, and a direction that faces toward the no-break portion from the break portion is set to face toward the center of the cap plate.

9. A battery module comprising:
a plurality of rechargeable batteries each comprising a case that accommodates an electrode assembly, a cap plate coupled to one side of the case, and a plurality of vent portions in the cap plate along a length direction of the cap plate;
wherein a vent line extends along an alignment direction of the plurality of rechargeable batteries, the vent line being configured to receive a gas emitted from the plurality of vent portions.

10. The battery module of claim 9, wherein the rechargeable battery further comprises an electrode terminal that protrudes from the cap plate and is electrically coupled with the electrode assembly, the electrode terminal comprises a pair of electrode terminals that are respectively located at opposite ends of the cap plate,
each of the vent portions comprises:
a break portion having a first notch configured to be ruptured by an internal pressure of the case; and
a no-break portion coupled with the break portion,
wherein the no-break portion is between the pair of electrode terminals, a direction that faces toward the break portion from the no-break portion is set to face toward the vent line, and the vent line is located to pass through a center side of the cap plate.

11. The battery module of claim 9, wherein the rechargeable battery further comprises an electrode terminal that protrudes from the cap plate and is electrically coupled with the electrode assembly, the electrode terminal comprises a pair of electrode terminals that are respectively located at opposite ends of the cap plate,
each of the vent portions comprises:
a break portion having a first notch configured to be ruptured by an internal pressure of the case; and
a no-break portion coupled with the break portion,
wherein the no-break portion is disposed further away from a center of the cap plate than the pair of electrode terminals, a direction that faces toward the break portion from the no-break portion is set to face toward the vent line, and
wherein the vent line comprises a pair of vent lines that are respectively located at the opposite ends of the cap plate, and located further away from the center of the cap plate than the pair of electrode terminals.
